(19) United States
(12) Patent Application Publication
(10) Pub. No.: US 2007/0018496 A1
(43) Pub. Date: Jan. 25, 2007

(54) Decorative covering for vehicle wheel

(76) Inventor: Michael Eugene McCorquodale, Houston, TX (US)

Correspondence Address: DELPHINE M. JAMES, 2656 SOUTH LOOP WEST #170, HOUSTON, TX, 77054, US

(21) Appl. No.: 11/186,430

(22) Filed: Jul. 21, 2005

(51) Int. Cl. B60B 7/00

(52) U.S. Cl. 301/37.11

(57) ABSTRACT

The present invention provides a decorative covering for any type of wheel vehicle of self propelled motorized vehicles including automobiles, motorcycles, and other similar type of motorized vehicles. The decorative covering comprises a coated layer overlaying an adhesive layer for attachment to the outer face of the wheel of a self-propelled vehicle. In the preferred embodiment, a decorative covering is specifically dimensioned to fit each groove in the outer face of the vehicle. The decorative covering is generally made of a polymer vinyl coating of any aesthetically pleasing designed pattern or color. The coating can also be treated with ornamental particles such as sparkles.

### BACKGROUND

This invention relates to a decorative covering the wheel of a self-propelled or motorized vehicle. More specifically, the decorative covering is made for wheels of automobiles, motorcycles, and similar motorized vehicles. The attachment of reflective material to bicycle wheels is known in the art. The reflective material is attached to the bicycle wheels for enhancing visibility for safety during riding a bicycle. The present invention provides a unique of decorative covering a wheel of a self-propelled vehicle such as an automobile, truck or similar vehicle.

### SUMMARY

One of the major objectives of the present invention is to provide a decorative covering for any type of wheel including spinners. The decorative covering comprises a coated layer and an adhesive layer for attachment to the outer face of the vehicle. In the preferred embodiment, a decorative covering is specifically dimensioned to fit each groove in the outer face of the vehicle. The decorative covering is made of a vinyl coating of any aesthetically pleasing designed pattern or color. The coating can also be treated with decorative ornamental particles such as sparkles or crushed stone.

### BRIEF DESCRIPTION OF DRAWINGS

The drawings and the accompanying description illustrate the present invention.

FIG. 1 is a frontal view of a wheel vehicle without a covering.

FIG. 2 is a side view of the wheel.

FIG. 3 is a frontal view of the wheel with the decorative covering.

FIG. 4 a cross-sectional view of the decorative covering.

FIG. 5 illustrates the component of one type of kit uninstalled.

FIG. 6, 6A, 6B are examples of different type of wheels.

### DETAILED SPECIFICATION

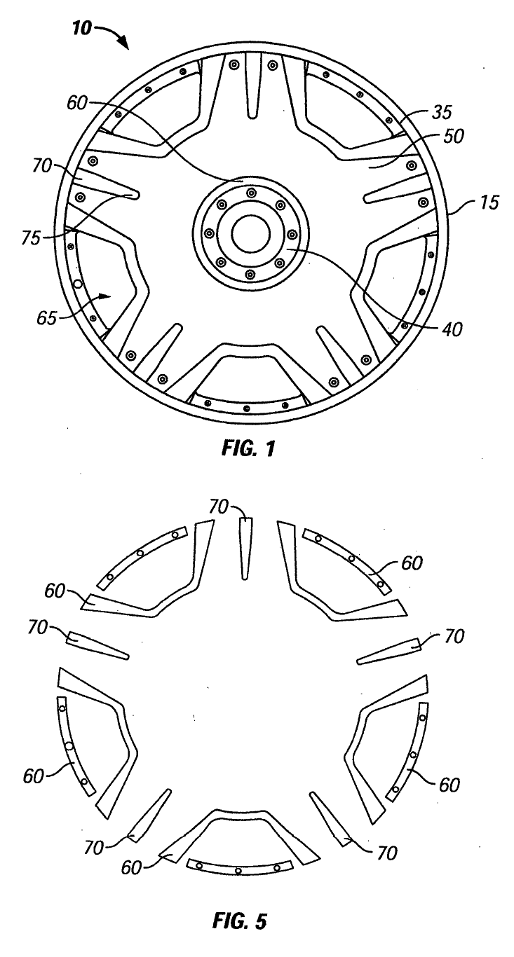

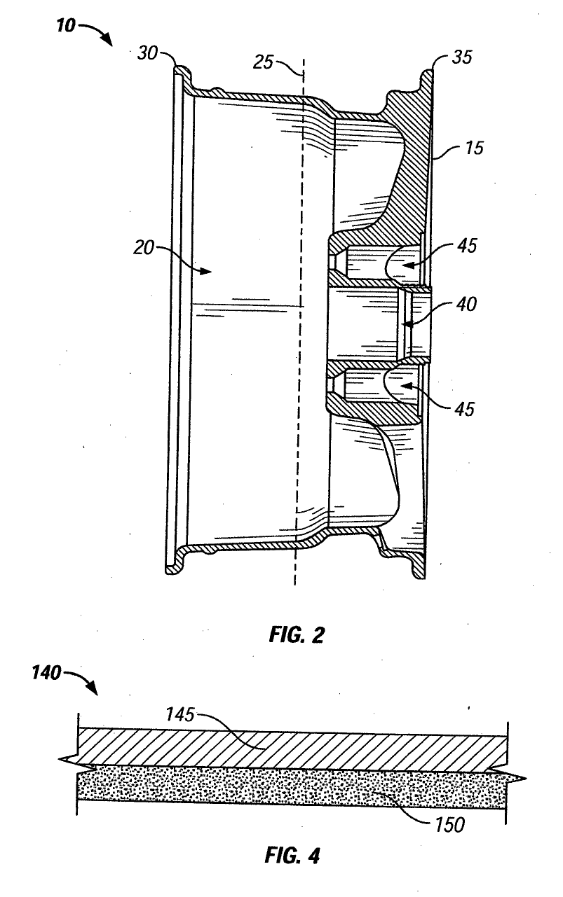

The present invention is a decorative covering for any type of wheel for a self-propelled vehicle such as an automobile, motorcycle or similar type of motorized vehicle. Referring to FIG. 1, there is shown a perspective view of a standard wheel (10) of a self propelled vehicle, an automobile, without the decorative covering of the present invention. Wheel (10) is generally made of a durable metal material such as steel, aluminum or another suitable material. Aluminum wheels are lighter and more impact absorbent. FIG. 2 illustrates a side view of wheel (10). The wheel (10) is constructed of a circular frame comprising an outer side (15), an inner side (20). The inner side (20) and the outer side (15) are adjoined along central axis (25). Rim (30) circumferentially surrounds inner side (20) and rim (35) circumferentially surrounds outer side (15). Inner side (20) and outer side (15) both have a circular disc shape interior face.

In operation, the inner side (20) of wheel (10) is mounted onto hub (not shown) of the vehicle which has short extending studs or lugs onto which the wheel mounts. Surrounding the center (40) of wheel (10) are circular openings (45) which mounts onto the hub (not shown) of wheel (10). Lug nuts (not shown) securely fasten the wheel onto the hub (not shown).

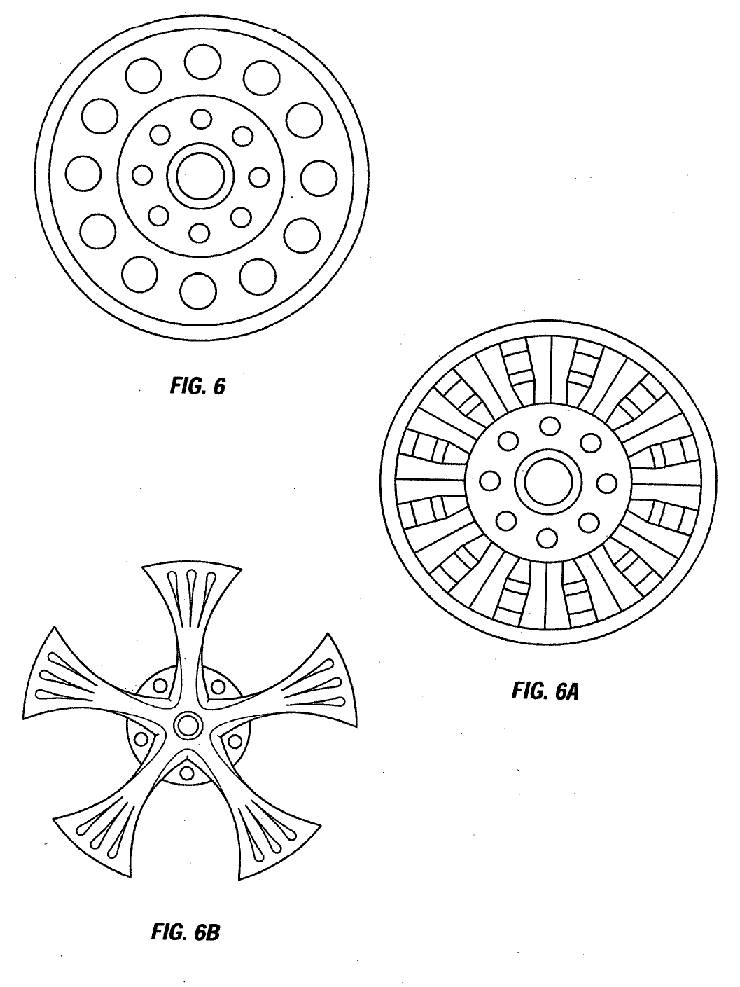

As shown in FIG. 1 interior face (50) of outer side (15) has a circular disc shape with a smooth surface area and is disposed within rim (35). In the illustrated embodiment interior face (50) further comprises a plurality of grooves (60, 70) and a plurality of openings (65). The plurality of openings (65) surrounds the outer peripheral edge of interior face (50) of outer side (15). As shown each opening (65) is surrounded by first groove type (60). In this illustrated wheel, each opening has a trapezoidal shape. Surrounding each opening (65) is first groove type (60) having a similar trapezoidal shape. Second groove type (70) extends from near the rim (35) to an intermediate point (75) near the center of the interior face (50). The structure of the interior face (50) of a outer side (15) of a wheel (10) is not limited to the example illustrated in FIG. 1. FIG. 6, 6A, and 6B illustrate several other types of wheels with alternative design structures. The present invention can be adapted for any type of wheel.

Referring to FIG. 3, there is shown a frontal view of the outer face (15) of wheel (10) with the decorative covering of the present invention installed. In this embodiment, each first groove type (60) and second groove type (70) is overlaid with a decorative covering. However, alternatively a partial number of the first groove type (60) and second groove type (70) is overlaid with the decorative covering. Alternatively, each groove type (60, 70) can be left uncovered and then the rest of the area of the interior face (50) can be overlaid with the decorative covering. Alternatively, each groove type (60, 70) can be left uncovered and then a partial area of the interior face (50) can be overlaid with the decorative covering. Alternatively a partial number of the first groove type (60) and second groove type (70) is overlaid with the decorative covering along with a partial area of the interior face (50) can be overlaid with the decorative covering.

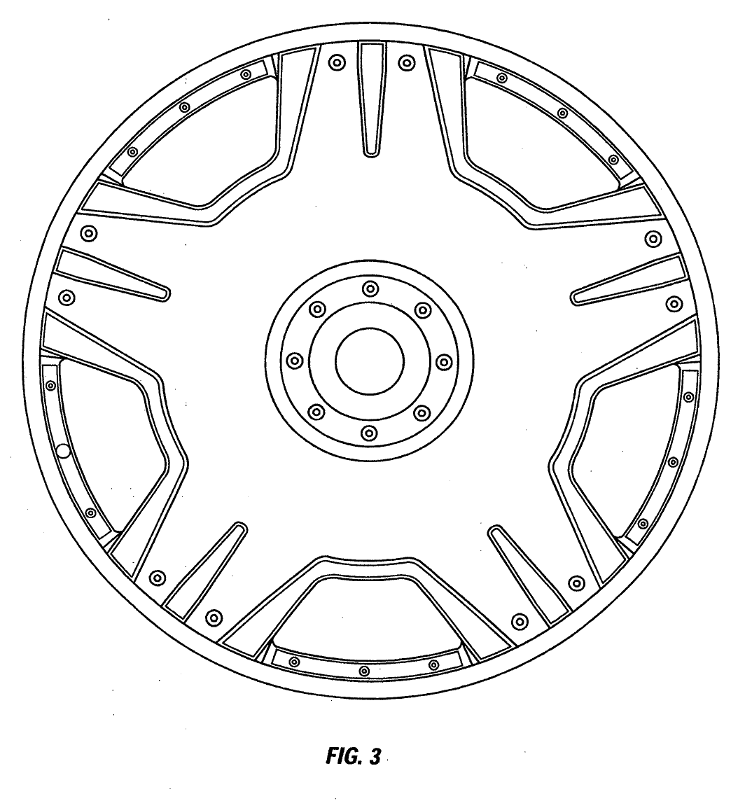

Referring to FIG. 4, the decorative covering (140) comprises a coating layer (145) superimposed upon a bottom adhesive layer (150). The coating layer (145) is generally made of a polymer vinyl. The coating layer (145) can be manufactured in any color or aesthetically pleasing design pattern. Additionally, the coating layer (145) can be further treated with an ornamental material securely embedded within the coating layer such as a sparkling material, crushed stone (i.e. Diamonds, ivory), or another such ornamental material. The adhesive layer (150) is used to securely bond the coating layer into the surface area of the interior face (50) of outer side (15) as shown in FIG. 3. The top layer can be made of reflective material.

Referring to FIG. 3 there is shown a kit manufactured for the wheel shown in FIG. 1. As shown the kit comprises a covering for each first groove type (60) and second groove type (70) desired to be covered. Alternatively, kits can be developed for each alternative type of placing the decorative covering upon interior face (50) of outer side (15) shown in FIG. 1 as described above. In alternative embodiments, a spinner plate can be coaxially and independently rotatably mounted to interior face 50 of outer side (15). As the wheel rotates, the spinner plate rotates freely and independently of the wheel. In this embodiment, the interior face 50 can be decorated as described above. Additionally, spinner plate can be decorated separately or in conjunction with interior face 50.

What is claimed is:

1. A decorative wheel for a self-propelled motorized vehicle, the wheel comprising:
a circular frame having an inner side and an outer side,
a rim surrounding the outer side and the inner side;
the outer side having circular shaped disc interior face with a central point, the interior face being disposed within the rim;
a plurality of grooves of a predetermined size and shape, each groove strategically incorporated into the interior face at a predetermined location;
a decorative covering having a plurality of pieces, each piece dimensioned to seat within a corresponding groove;
the plurality of pieces covering a portion of the number of grooves or each and every groove on the interior face;
each piece further comprising:
dimensioned to cover partially or the entire area within the groove;
a top layer superimposed upon and bonded to a bottom layer;
a top layer being made of a decorative coating material;
the bottom layer being made of an adhesive material for bonding into the groove therein.

2. The decorative wheel of claim 1 wherein the decorative coating material is made of poly vinyl of any color and/or any aesthetically pleasing design pattern.

3. The decorative wheel of claim 1 wherein the decorative coating further comprises a plurality of decorative ornamental pieces incorporated therein.

4. The decorative wheel of claim 1 further comprising:
at least one opening strategically positioned within the interior face; and
a subset of grooves surrounding the at least one opening.

5. The decorative wheel of claim 1 further comprising:
a subset of the plurality of pieces configured to selectively and alternatively cover a portion thereof or an entire area of the interior face;
each piece of the subset configured to seat upon a predetermined area of the interior face outside of a groove;
each piece further comprising:
a top layer superimposed upon and bonded to a bottom layer;
a top layer being made of a decorative coating material;
the bottom layer being made of an adhesive material wherein the bottom layer bonds to the predetermined area of the interior face thereto.

6. A decorative wheel for a self-propelled motorized vehicle, the wheel comprising:
a circular frame having an inner side and an outer side,
a rim surrounding the outer side and the inner side;
the outer side having circular shaped disc interior face with a central point, the interior face being disposed within the rim of the outer side;
a plurality of grooves of a predetermined size and shape, each groove strategically incorporated into the interior face at a predetermined location;
a decorative covering having a plurality of pieces, each piece being dimensioned to seat upon a predetermined area of the interior face outside of each groove;
the plurality of pieces configured to cover a portion of or the entire area of the interior face;
each piece further comprising:
a top layer superimposed upon and bonded to a bottom layer;
a top layer being made of a decorative coating material;
the bottom layer being made of an adhesive material wherein the bottom layer bonds to the area of the interior face thereto.

7. The decorative wheel of claim 6 wherein the decorative coating material is made of poly vinyl of any color and/or any aesthetically pleasing design pattern.

8. The decorative wheel of claim 6 wherein the decorative coating further comprises a plurality of decorative ornamental pieces incorporated therein.

9. The decorative wheel of claim xx further comprising:
a spinner plate rotatably and co-axially mounted to the outer side of the wheel overlaying the interlaying interior face thereon.

10. The decorative wheel of claim 10 wherein the spinner plate is partially or fully covered with the decorative coating material.

11. A kit for decorating the interior face of the outer side of a wheel of a self propelled motorized vehicle, the kit comprising:
a plurality of pieces for seating within a groove strategically incorporated within the interior face;
the plurality of pieces for covering a portion of the grooves or each and every groove incorporated on the interior face;
the entire number of a decorative covering having a first set of pieces;
each piece further comprising:
dimensioned to cover partially or the entire area within the groove;
a top layer superimposed upon and bonded to a bottom layer;
a top layer being made of a decorative coating material;
the bottom layer being made of an adhesive material for bonding into the groove therein.

12. The kit of claim 11 further comprising:
a subset of the plurality of pieces configured to selectively and alternatively cover a portion thereof or an entire area of the interior face;
each piece of the subset configured to seat upon a predetermined area of the interior face outside of a groove;
each piece further comprising:
a top layer superimposed upon and bonded to a bottom layer;
a top layer being made of a decorative coating material;
the bottom layer being made of an adhesive material wherein the bottom layer bonds to the predetermined area of the interior face thereto.

13. The kit of claim 11 wherein the decorative coating material is made of poly vinyl of any color and/or any aesthetically pleasing design pattern.

14. The kit of claim 11 wherein the decorative coating further comprises a decorative ornamental piece incorporated therein.
